(19) United States
(12) Patent Application Publication
(10) Pub. No.: US 2004/0172621 A1
(43) Pub. Date: Sep. 2, 2004

(54) System with macro commands

(76) Inventor: Fabien Marcel Jacques Guillorit, Eindhoven (NL)

Correspondence Address: Corporate Patent Counsel, Philips Electronics North America Corporation, P O Box 3001, Briarcliff Manor, NY, 10510, US

(21) Appl. No.: 10/482,139

(22) PCT Filed: Jun. 20, 2002
(86) PCT No.: PCT/IB02/02551

(30) Foreign Application Priority Data
Jul. 5, 2001 (EP) 01202590.4

(51) Int. Cl. G06F 9/44

(52) U.S. Cl. 717/120

(57) ABSTRACT

In a home system, sequence of received user commands are stored. A matching unit determines whether matching sequences of commands are received repeatedly. If so the system adds a new macro command to a user interface. The new macro command becomes user selectable so that in response to user selection of the further command, the user interface sends control signals for executing a series of commands corresponding to commands of the first sequence. In particular the invention is used in a system with a bus that allows the user to plug apparatuses into the bus. In this cases commands for mutually different ones of the apparatuses, given for example from different user interfaces, are stored and the system includes commands for these mutually different apparatuses in the macro.

The invention relates to a system that is capable of executing macro commands, and in particular to a home system that comprises a audio/video home devices connected via a bus.

PCT patent application WO 98/59284 describes a method and apparatus for creating macro commands for a home network. The network receives commands for example from inputs in an HTML page. Initially, each input, when activated, causes execution of a user commands. A macro command involves execution of a series of such user commands upon activation of a single, newly defined input for that macro command.

A home network with home devices as defined in WO 98/59284 (WO 98/59284 excludes general purpose computers from the definition of home devices) interconnects electronic devices that are typically found in the home. Such a network is operated by consumers, which are usually not skilled technicians. In practice, it has been found that such unskilled users don't write their own new macros.

WO 98/59284 describes various ways of assisting the user to generate macro's. For example, the use of a preset macro is described for presetting the parameters of the system to some preference. A preset macro is generated by reading the values of parameters of the system when the system is in the preferred state and copying these values into commands in the macro for setting these parameters. In another example, a macro is generated when the user instructs the system to record a macro. The system records the commands given by the user after this instruction into the macro. In another example macros are prepared externally, for example by the manufacturer of a device in the system.

These solutions are limited to macros for predetermined functions with predetermined patterns of instructions. This does not cover all macros that might be of real help to the user, all the less in home systems with an open bus, where the configuration of the system is not known in advance but depends on the types of apparatus that a particular user happens to have plugged into the system.

Amongst others, it is an object of the invention to provide for a system that allows unskilled users to profit from macro definition.

Amongst others, it is a further object of the invention to improve the ease of user control of a system with a bus into which different types of apparatus can be plugged in.

The invention provides for a system comprising

a user controllable device;

a user interface arranged to receive user selectable commands and to send control signals to the device for effecting execution of the commands;

a memory unit arranged to record a first sequence of received commands;

a matching unit for determining whether a second sequence of commands received subsequent to said first sequence matches said first sequence;

the system being arranged to add a further command to the user interface in response to detection that said second sequence matches said first sequence, the further command becoming user selectable so that in response to user selection of the further command, the user interface sends control signals for executing a series of commands corresponding to commands of the first sequence.

Thus, the system takes the initiative to select the content of a macro. It obtains the contents of the macro by copying sequences of commands that the user has used repeatedly to control the system. Matching sequences are inserted in system generated macros. Sequences of commands are said to match when they have the same lasting effect on the system after the completion of each sequence. That is, sequences that differ only in commands that have no lasting effect, such as later corrected erroneous commands or commands for temporary lookup of information, are still said to match. Such inconsequential commands need not be incorporated in the resulting series of commands of the macro.

In an embodiment the invention is implemented in a home system with a bus into which apparatuses can be plugged in by the user. In this case commands for different apparatuses can be included in a macro. The invention is especially useful for such dynamically “open” bus systems, because it is difficult to provide predefined macros or predetermined patterns of instructions for such open systems.

In a further embodiment, the system contains multiple interface modules for giving commands. Different modules (e.g. remote control units) are for example coupled to different hardware devices that interface to each other via the bus. Alternatively, different modules may be different software modules, each providing a different assignment of functions to user actuatable inputs and/or a different on screen display of a user interface for a respective apparatus or function. According to the invention a sequence of command different ones of such modules can be recorded and matched to another sequence of commands. Thus, a macro may be provided for issuing a series of commands for different apparatuses or functions. Without such a macro, execution of such a series of commands would require extensive switching between interfaces (e.g. different remote control units).

In an embodiment, the memory unit is incorporated in a device that is attached to the bus. To define macros the memory unit stores commands passed over the bus (an optionally commands, if any, given directly to the device in which the memory unit is incorporated, i.e. not via the bus). Thus, memory unit enables the generation of macro's that span different devices.

In further embodiment of the system according to the invention, an input for activating the added command is attached in at least one of the user interface modules from which a command in the original series of commands was received. By “attaching” to an input is meant that system is programmed to execute the added command when the input is activated. For example, if the macro commands recording of video information from a source apparatus at a recording apparatus, the macro command to do so may be attached automatically to a button on the user interface module for the source apparatus and/or the user interface module for the recording apparatus.

In another embodiment, sequences of commands are filtered, so that the macro command comprises only commands that relate to common data.

These and other advantageous aspects of the system, method and apparatus according to the invention will be described in more detail using the following figures.

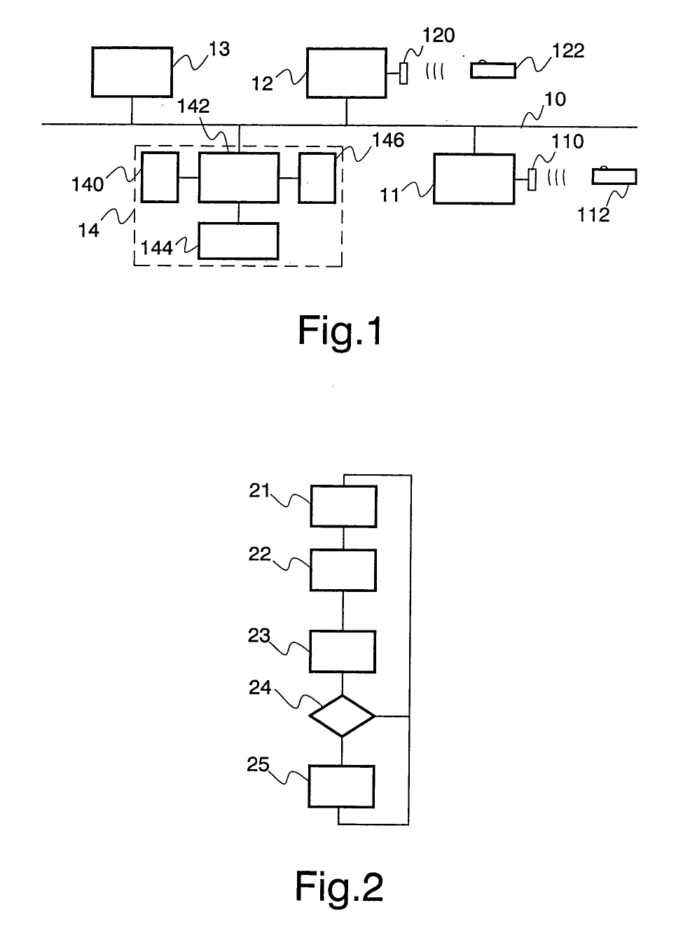

FIG. 1 shows a system of home apparatuses

FIG. 2 shows a flow-chart for defining a macro instruction

FIG. 1 shows a system of home apparatuses 11, 12, 13, 14 interconnected by a bus 10. Although a linear bus structure is shown, any bus structure, such as a tree structure in the case of a P1394 bus, may be used. By way of example, two of the apparatuses 11, 12 are shown to have an input 110, 120 for remote control signals for remote control units 112, 122. A third apparatus 14 is shown in more detail. A control unit 142 containing for example a microprocessor, a memory 140, a user interface 144 and a display unit 146 are shown.

In operation, a user may use the system for example to perform operations like playing or recording video or audio information in the home. For example, one apparatus 11 may be a video source and/or recording device, such as a video recorder, a DVD player, a magnetic disc unit or the like, and another apparatus 14 may be a televisions set. In this case, the user instructs the video source 11 to retrieve the video information and send it to the television set 14 via bus 10. The user instructs television set 14 to receive the video information from the bus 10, to decode it and to show it on display unit 146. In another example, the user instructs the television set 14 to output video information via the bus 10 to a recording device 12 and the user instructs recording device to receive the video information and to record it.

Yet another one of the apparatuses 12 may be a set-top box 12 for receiving video signals from a cable system, or an Internet interface unit 13 etc. These may also serve as image sources, video sources, audio sources or data sources of information that may be displayed, output or recorded in the system, or as receivers for such information.

All such operations are controlled in more or less detail by the user. Some operations are started by a single user command, but often the user will have to enter a series of two or more commands to cause the system to execute the operation, indicating for example a data source and a data destination, as well as what has to be done with the data. In one mode, the user uses a central user interface 144 for entering all such commands. In another mode, the user uses one or more remote control units 112, 122 to enter the commands. Entry of commands may be an interactive process, in which a menu or a dialog box (e.g. an image showing various buttons to select commands) is displayed, for example on display unit 146, in order to show the user which commands can be entered and how.

The system enables the user to define new commands, so-called “macro” commands which are composed of two or more commands that can be given to the system. Once a new macro command has been defined, the system enables the user to select this new command, for example by adding the new command to a menu, adding a “button” for the command to a dialog box or associating the command with a button, or combination of buttons on a remote control unit (generally, this will be called adding the command to the system). When the user selects the command, the system executes the commands of which it is composed in response.

For example, the macro command may instruct the system to record information that is currently displayed on a specified display device on a specified recording device.

In an embodiment selection of the macro command occurs when the user enters the initial command of the commands of which the macro command is composed, followed within a predetermined time by entering a predetermined generic “execute macro” command. This supports the user in that, if he or she starts entering the initial command of the commands of which the macro is composed and then remembers that the macro has been defined, he or she can select the macro by subsequently entering the generic macro command.

In order to help the user define macro commands, the system takes the initiative to suggest new macro commands. The system monitors commands given by the user and when the system detects that the user has given two or more series of commands match with each other, the system constructs a sequence of commands for the matching part of the series of commands and asks the user whether a macro command should be added for executing this sequence of commands.

FIG. 2 shows a flow-chart of steps for adding macro commands in this way. In the system of FIG. 1, these steps are executed for example by control unit 142. In a first step 21, the control unit 142 monitors commands given by the user and detects whether a new command has been entered that is the end of a potential macro sequence. The control unit 142 identifies a series of commands as a potential macro sequence for example if the successive commands in the series are given less than a predetermined time (for example 10 seconds) after one another. The end command of such a potential macro sequence is not followed by another command within a predetermined time (for example the same predetermined time as used to identify the potential macro sequence, of a longer time, for example 30 seconds).

In a second step 22, control unit 142 stores the potential macro sequence in memory 140. If necessary space for storing is created in memory, for example by discarding one or more least recently used potential macro sequences. In a third step 23, control unit 142 searches through memory 140 for a previously stored potential macro sequence that matches the newly stored potential macro sequence with a matching part that does correspond to the sequence of commands of an existing macro command. In a fourth step 24, control unit 142 branches back to the first step if it finds no such matching potential macro sequence in memory 140.

If control unit 142 does find such a potential macro sequence, it executes a fifth step 25, suggesting to the user to define a new macro command for the potential macro sequence, for example by displaying a message on display unit 146 that a potential new macro sequence has been found, together with a listing of the effects of the commands of the potential new macro sequence. Subsequently, the control unit resumes from the first step 21.

If the user enters a command to approve addition of the new macro command control unit 142 adds the command to the system, for example so that upon entering a command from user interface 144 the commands from the potential new macro sequence, or the matching part of the sequence are generate. However without deviating from the invention other interfaces 112, 122 may be used to trigger execution of the macro commands. The control unit 142 may select automatically which interface may be used, for example implementing the macro command on one or all of the interfaces from which commands where received in the potential new macro sequence. Alternatively, the control unit 142 may ask the user to indicate to which interface the new macro command should be attached.

Preferably the system has a command that allows the user to enable and disable suggestion of the new macro command in the fifth step (for example by selecting a “disable/enable macro suggestion” button in a dialog box). This allows the user to restrict macro suggestions to times when they are desired.

The control unit 142 may use various types of criteria in the third step 23 to determine whether potential macro sequences match each other. In one embodiment. the control unit simply detects a match if two sequences consist of identical commands in the same order. In another embodiment a match is detected if in addition to the identical commands the sequences contain additional commands that do not affect the end result of the sequences, and/or if the commands occur in different order in the two sequences, as long as this does not effect the end result.

In a further embodiment of the matching in the third step, control unit 142 generalizes the parameters of the commands in the sequences. That is, if commands with the same function in respective ones of the sequences differ only in parameters (e.g. “output video to the bus” commands that differ only in the source apparatus of the video), control unit 142 treats them as potentially matching commands, with substitution of parameters, when two potential macro sequences are compared. The substitution relates two parameter values to each other, one from each of the matching sequences. When these parameter values are substituted for each other according to this relation in all corresponding commands of the matching sequences, these sequence are said to match.

In the generated macro command, the parameter value may be included as a parameter of the macro command, to be entered by the user when he or she selects the macro command. As an alternative, the control unit 142 stores a state description of the system at the start of and/or during execution of each potential new macro sequence in memory 140, together with the macro sequence (the state description contains information about active data transport streams, channels to which the apparatuses are tuned etc.). In this alternative the control unit determines whether the substitution also relates parameters in the state of the system stored for the respective potential new macro sequences. If so, the control unit 142 includes in the newly generated macro a command for reading the relevant parameter from the state of the system.

Thus, for example, suppose the two matching potential macro sequences are both sequences to record information on a disk unit. In this case, the control unit 142 will suggest a macro for storing information on the disk unit. But suppose one potential macro sequence commands that information from a web page received at an Internet interface is stored, and the other sequence commands that information from a television channel received at a tuner is stored. Suppose further that control unit 142 finds that a parameter of a state of the system indicates that before the start of the two sequences the source of information displayed on display unit 146 is respectively the Internet interface and the tuner. Then control unit 146 will add a command to the macro to read the parameter of the state of the system during execution of the macro to determine the source of the information displayed on the display unit 146, and commands in the macro will use the resulting value of the parameter to indicate the source of the information that is stored on the disk unit.

In an embodiment of the first step 21, the control unit 142 restricts the potential macro sequences to sequences of coherent commands, wherein each command is said to be “connected” to another command in the sequence in the sense that the command affects or uses data that is affected or used by the other command in the sequence, and wherein all commands are connected to one another directly, or indirectly via other commands.

In an embodiment, control unit 142 includes only commands received via the control interface 144 in the potential macro sequences generated in the first step. In another embodiment control unit 142 monitors the bus 10 to detect whether commands have been received at other interfaces, such as receivers 120, 110 for signals from remote control units 122, 112, or such as control buttons of apparatuses 11, 12, 13. In this embodiment control unit 142 also incorporates the commands thus detected in the potential macro sequence, stores them in memory 140 and uses them in the third step 23 during matching.

1. A system comprising
a user controllable device;
a user interface arranged to receive user selectable commands and to send control signals to the device for effecting execution of the commands;
a memory unit arranged to record a first sequence of received commands;
a matching unit for determining whether a second sequence of commands received subsequent to said first sequence matches said first sequence;
the system being arranged to add a further command to the user interface in response to detection that said second sequence matches said first sequence, the further command becoming user selectable so that in response to user selection of the further command, the user interface sends control signals for executing a series of commands corresponding to commands of the first sequence.

2. A system according to claim 1, wherein the device is one of a plurality of devices, the system comprising a bus that allows the user to plug apparatuses containing one or more of the devices into the bus, the memory unit being incorporated in a device plugged into the bus, the memory unit being arranged to record commands for mutually different ones of the apparatuses in said first sequence, the system being arranged to include commands for mutually different apparatuses in said series of commands.

3. A system according to claim 2, wherein the system is arranged to determine whether the commands of a matching part of the first and second sequence are directly or indirectly related to each other, a direct relation existing between two commands of the matching part when the two commands refer to the same data transported via the bus, an indirect relation existing when a first one of the two commands is directly related to a further command in the matching part that is directly or indirectly related to a second one of the two commands, the system using only matching parts in which the commands have been found to be directly or indirectly related for generation of the series of commands.

4. A system according to claim 2, the user interface comprising a plurality of user interface modules for different ones of the apparatuses, the memory unit and the matching unit being arranged to record and match commands received via any of the user interface modules of said plurality in said first sequence.

5. A system according to claim 4, wherein the system attaches the further command to an input of at least one of the user interface modules from which a command of the first or second sequence of commands was received.

6. A system according to claim 4, wherein the matching unit identifies a first and second, user provided parameter used in at least two of the commands of the first and second sequence respectively, and determines that the first and second sequence match irrespective of whether the first and second parameter are equal, the system including entry of a further parameter in the further command, the further parameter being substituted for the first parameter in the series of commands.
